(19) United States
(12) Patent Application Publication
(10) Pub. No.: US 2022/0108814 A1
(43) Pub. Date: Apr. 7, 2022

(54) Surface Flashover and Material Texturing for Multiplying and Collecting Electrons for Nuclear Thermal Avalanche Cells and Nuclear Battery Devices

(71) Applicants: Robert W Moses, Poquoson, VA (US); Sang H. Choi, Poquoson, VA (US)

(72) Inventors: Robert W Moses, Poquoson, VA (US); Sang H. Choi, Poquoson, VA (US)

(21) Appl. No.: 17/492,373

(22) Filed: Oct. 1, 2021

Related U.S. Application Data
(60) Provisional application No. 63/086,569, filed on Oct. 1, 2020.

(51) Int. Cl. G21H 1/10; G21H 1/04

(52) U.S. Cl. CPC G21H 1/103; G21H 1/106; G21H 1/04

(57) ABSTRACT

A modified Nuclear Thermionic Avalanche Cell (NTAC) to reduce back-scatter losses of avalanche electrons emitted by a NTAC. The present invention provides a novel topological surface configuration for electron collector layers in NTAC devices. Sawtooth configurations of the surface configurations of electron collector layers allow for the recapture of back-scattered electrons, increasing the efficiency of NTAC devices as well as reducing thermal loading and increasing NTAC efficiency.

This application claims the benefit of U.S. Provisional Patent Application No. 63/086,569, filed on Oct. 1, 2020.

### BACKGROUND

The present invention relates to direct energy conversion systems referred to as “Nuclear Thermionic Avalanche Cells” (NTACs). The NTACs are described in detail in U.S. Pat. No. 10,269,463. The NTACs provide a significant improvement over prior devices, specifically nuclear batteries or nuclear capacitors. The prior nuclear devices harness electrons from the valence band of materials but do so using the low energy capacity of the alpha and beta particles. The energy and number of beta particles emitted from a radioactive decay process are very small, resulting in the conversion systems using these beta particles having very small power densities.

In addition, a nuclear battery subsidizes the beta decay electrons and the alpha particles to generate electron disparity of a p-n junction within the frame of only the valence band of electrons in the material utilized at an electron source. As a consequence, these nuclear batteries only render a low energy density system. As a result, thus far nuclear batteries, while ubiquitous, have had fairly limited uses such as such as in spacecraft, pacemakers, underwater systems, remote sensors and automated scientific.

The NTAC as described in the '463 patent resolved this problem by harnessing the intra-band electron potential wells in materials having large differences between the intra-band electron potential wells and the valence band electron potential wells. This results in energy densities as much as five orders of magnitude higher than prior art nuclear batteries. The NTAC can also utilize radioactive waste, providing a means to harvest significant amounts of energy from what is currently being treated as spent fuel that must be stored in a safe manner. The power generated by the NTAC devices creates opportunities for the use of powerful, long-lasting (as much as thirty year life span) power sources that can be utilized for such things as large-scale space exploration, electric propulsion for aircraft, electric vehicle operation, autonomous residential power units, commercial dedicated power units, grid supplements, many DOD and DOE applications, as well as propulsion power for ships and submarines.

Such batteries, however, are reliant upon the thermal agitation of electrons. The greater number of electrons agitated by radiation, and the greater the energy densities, the greater amount of heat that is generated in the process. Not only is heat generated during use of nuclear batteries, but current nuclear battery designs are always “on” (i.e., always emitting γ radiation during the decay life of the radiation source, and therefore always generating heat whether the resulting electrical energy is being utilized or not). This is because the present designs have the radiation source sealed within a battery, and thus constantly generating heat and electrical energy. Any means for control of the reaction is of necessity control of the produced heat and resulting electrical energy. However, regardless of regulation and control of the output of such devices, there is no means by which to control the reaction itself—the production of heat and electrical energy occurs unstopped throughout the decay life of the radiation source. The current NTAC designs pose issues with thermal loading inside the “always on” device and with extracting all the electrons created inside the device that are necessary for achieving the energy density. Both thermal loading and electrical output pose huge application issues for the current patented NTAC designs. All energy to be extracted by current NTAC designs is by harvesting electrons to create electrical energy that can be conducted to areas outside the NTAC device for use by other devices that are powered only electrically (i.e., electronics). Whether electrons energized and liberated through the coupling process with high energy photons and electrons are circulated or not through a load circuit, thermal energy accumulates in the NTAC device as a result of resistivity by inelastic collision of energetic electrons that increase the system temperature. In addition, the coupling process of materials with high energy gamma photons does not fully use the incident energy of photons or electrons. Therefore, the rest contributes as a thermal energy to raise the system temperature. In the device structure of a NTAC, an electron collector captures avalanche electrons emitted from the NTAC emitter, thereby conducting electrical power to be utilized as with any other electrical power source. Emitted avalanche electrons, however, are energetic and may carry up to several kilo-electron volts (“keV”) of energy. When such energetic electrons cross the vacuum gap between the emitter and collector surfaces in a NTAC and impact the collector surface, a large number of the higher-energy electrons are back-scattered off of the collector surface and therefore create inefficiencies in the capture of electrons and generation of power from a NTAC. Current flat surface designs for electron collectors cause more electron back-scatter and become increasingly less efficient as the energy and number of electrons striking the surface of the electron collector increases.

In order to maximize electron emittance from the selected emitter material across the vacuum gap to the electron collector, current patented NTAC designs utilize emitter spikes on the surfaces of the emitter materials facing electron collectors. However, the current patented NTAC designs do not show or claim surface structures and material texturing on the electron collectors for enhancing capture of the liberated electrons so that they cannot recombine with the emitters.

It is therefore desirable to enhance and maximize electron collection by incorporating surface structures and material texturing that capture liberated electrons and disallow their recombination with the emitter surfaces. Such means of electron capture is important not just to control heat and electrical output but also to reduce mass and complexity of “electron getter” concepts aimed at boosting electrical output and/or overall system efficiency. Such electron multiplier and collection means may be utilized in conjunction with NTAC cooling and isotope control means, described elsewhere. Furthermore, such electron multiplier and collection means that increases electrical output of the device may also possibly reduce the heat retained inside the device when electrons are trapped inside. Therefore, with the present invention, it is possible to reduce and/or alleviate the need for additional cooling means altogether. This may be important where weight and other considerations, including complexity and size, are important such as in spaceflight applications where weight and size are costly, and where unnecessary complexity can increase potential failure rates of missions. This is especially important in the new NTAC designs which are highly efficient, creating significantly more heat and electrical energy than their predecessors.

It is therefore an object of the present invention to provide novel electron collector surface topologies to minimize backscatter of emitted electrons and maximize the efficiency of power generation in nuclear thermionic avalanche cells and similar nuclear battery devices.

It is a further object of the present invention to provide means for controlling the thermal and electrical output of a nuclear battery.

It is yet a further object of the present invention to provide a modified nuclear thermionic device which is scalable and provides controllable power to be used in applications such as large scale space exploration, electric propulsion for aircraft, electric vehicle operation, autonomous residential power units, commercial dedicated power units, grid supplement, many DOD, DOT, DOE and civilian programs, as well as propulsion power for ships and submarines.

It is yet a further object of the present invention to provide devices and methods for controlling the generation of electrical and thermal power from spent nuclear material.

It is yet a further object of the present invention to provide a modified nuclear thermionic avalanche cell for sustained long-term controllable high energy production.

### BRIEF SUMMARY OF THE INVENTION

The invention as described herein is a novel topological design for electron collector surfaces within a Nuclear Thermionic Avalanche Cell or similar power generation systems.

In an embodiment of the present invention, the surface of an electron collector surface is topologically modified in order to reduce electron back-scatter and thereby increase the efficiency of a NTAC, reduce thermal loading of a NTAC, and increase the energy output of a NTAC of either or both thermal and electrical energy.

### BRIEF DESCRIPTION OF THE DRAWINGS

FIG. 1 shows the forward-scattering and back-scattering of electrons on the surface of a conducting collector in a NTAC.

FIG. 2 shows an illustration of the interaction of high-energy electrons across an insulator surface.

FIG. 3 demonstrates a simulation of back-scattered electrons impinging on an iron-rich material.

FIG. 4 is an illustration of the back-scattering of electrons at the collector surface of a NTAC.

FIG. 5 shows a novel topological collector surface design in accordance with an embodiment of the present invention.

### DETAILED DESCRIPTION OF THE INVENTION

The present invention provides a means for minimizing electron back-scatter losses in Nuclear Thermal Avalanche Cells (“NTACs”) through a novel topological surface design for collector surfaces in NTACs.

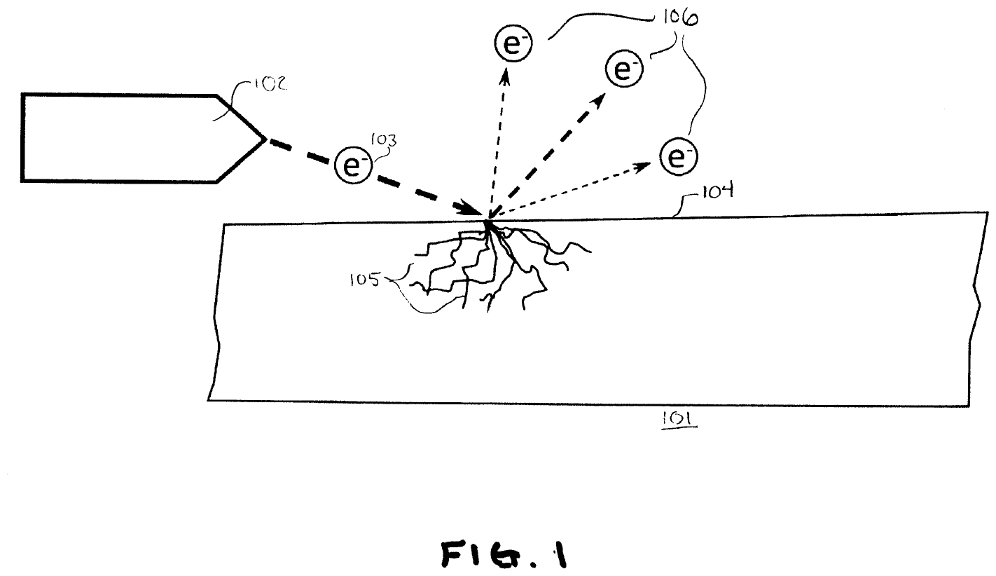

Referring now to FIG. 1, the forward-scattering and back-scattering of electrons on the surface of a conducting collector 101 in a NTAC of electrons striking a typical conducting electron collector is shown. The electron beam 102 (in the case of a NTAC the stream of electrons emitted from a NTAC emitter) projects one or more electrons 103 which strike the surface 104 of a conducting collector 101, producing the desired forward-scattering electrons into the conducting collector 101 as shown 105. However, a portion of the one or more electrons 103 striking the surface 104 will interact with the surface 104 in a manner that causes the emission of back-scattering electrons 106. These liberated back-scattering electrons 106 cause a net loss of energy. In addition, as the energy of the one or more electrons 103 increases, the greater the number of back-scattering electrons 106, thereby carrying away a larger portion of the energy imparted by the one or more electrons 103 and decreasing the efficiency of the NTAC device.

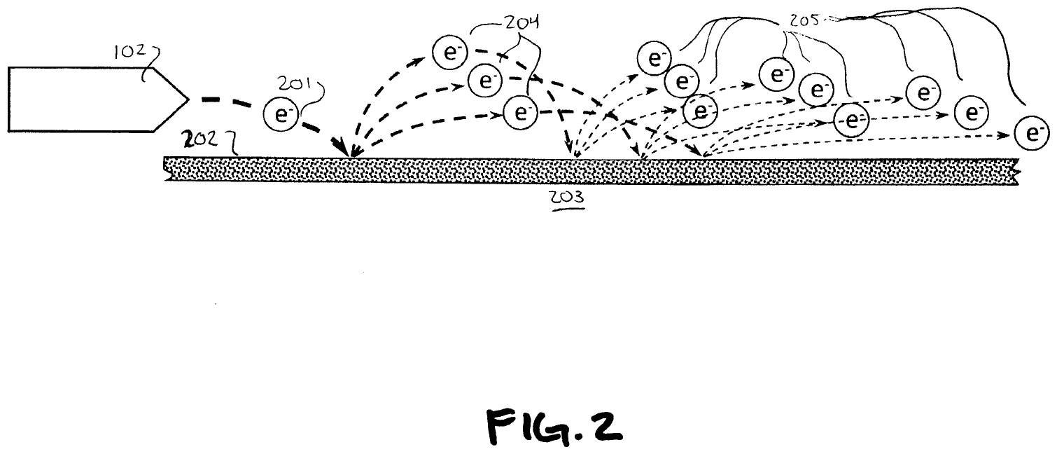

FIG. 2 illustrates the effect of a high-energy primary electron 201 from an emitter source 102 striking the surface 202 of an insulator material 203. This process is referred to as “surface flashover” where the primary electron 201 strikes the surface 202, which then emits secondary electrons 204 which are of lower energy than the primary electron 201 but are more numerous. The secondary electrons 204 also strike the surface 202, emitting tertiary electrons 205 which are more numerous than the secondary electrons 204. This behavior is similar to the behavior of electrons striking a surface under an electric field such as exists in collectors disposed within a NTAC device.

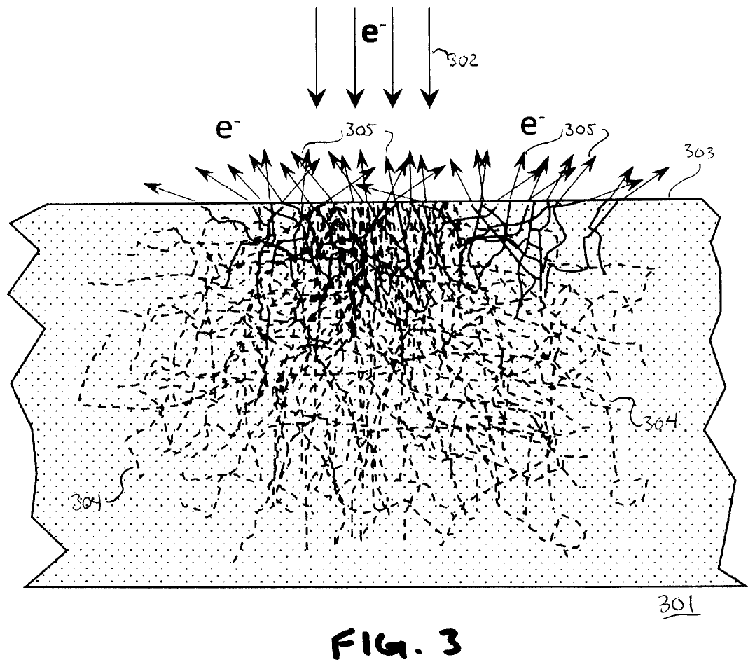

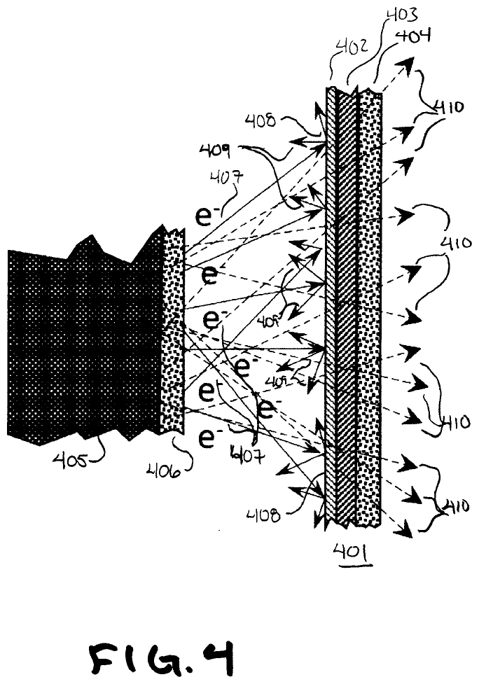

FIG. 3 illustrates an application of a Monte-Carlo simulation of the effect of electrons striking a ferrous or other conducting material. A Monte Carlo simulation of a 15 keV electron beam impinges on the surface of Fayalite (an iron-rich material with the formula Fe₂SiO₄) is shown. A similar back-scattering occurs on a collector surface. And with an increase in both the number and energy of electrons impinging upon a collector surface, the incidence of back-scattered electrons increases as well. So the higher the power (electron) output of a NTAC emitter, the higher the proportional losses will be due to back-scattering. At some theoretical limit, therefore, additional increases in emitter output will result in no corresponding increase in electron capture at the collector. The 15 keV electrons 302 strike the surface 303 of the Fayalite material 301, and result in the production of forward-scattering electrons shown by their scatter trajectories 304. The simulation also shows the back-scattering electrons 305. As the number and energy of the electrons 302 increase, so too does the energy and number of back-scattering electrons 305. The high output of avalanche electrons in a NTAC increase this effect significantly. FIG. 4 illustrates this effect. Because a NTAC layer 401 consists of a collector 402, insulator 403, and emitter 404, the emitted electrons 407 caused to be emitted from the emitter 406 by a γ-ray source 405 strike the surface 408 of the collector 402, and result is a large number of back-scattered electrons 407 in comparison to the transmission of energy through the NTAC layer 401 and the resulting γ-ray emission 410 from the emitter layer 404.

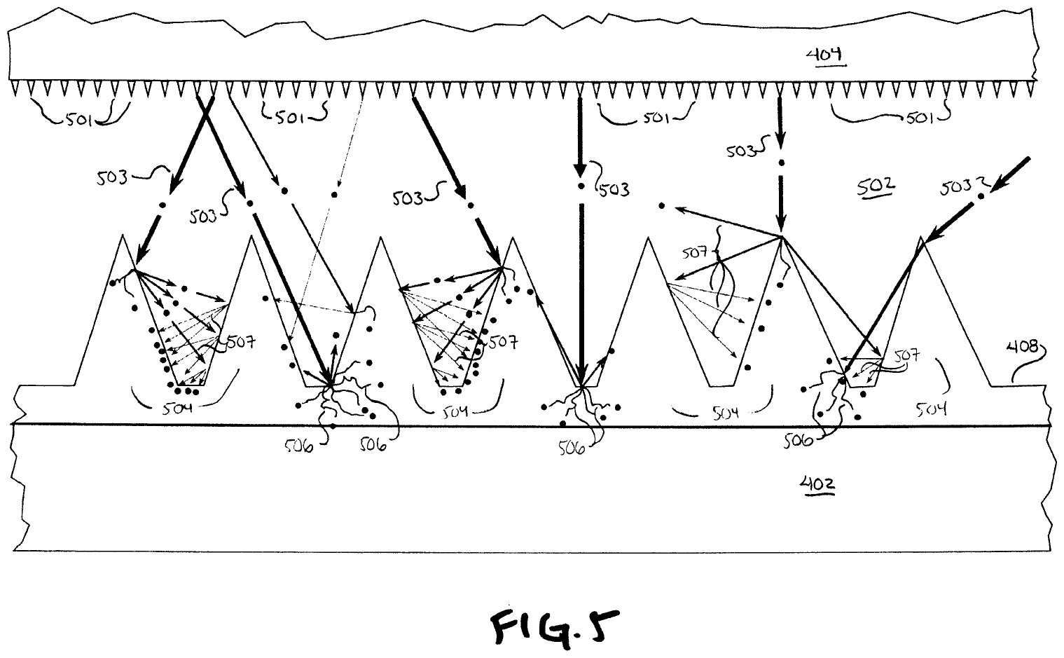

Referring now to FIG. 5, an embodiment of the present invention is shown. The emitter layer 404 and the collector layer 402 are separated by a vacuum gap 502. In a typical configuration, emitter spikes 501 are utilized to direct emission of electrons 503 from the emitter layer 404 to the collector layer 402. However, due to Coulomb scattering, the paths of the emitted electrons 503 are not consistently perpendicular to the surfaces of the emitter layer 404 and the collector layer 402. This inconsistency increases the backscattering effect the present invention ameliorates. Rather than a flat surface, the surface 408 of the collector layer 402 is modified topologically into a sawtooth configuration with spikes 504. As the electrons 503 strike the surface 408 of the collector layer 402, the sawtooth spikes 504 allow for both the forward-scattering of electrons as shown by the forward-scattering paths 506 but also allow for the recapture of the back-scattering electrons 507 as a result of the non-planar or non-flat surface structure of the collector layer 402. This novel non-planar surface configuration allows for the capture of energy lost due to backscatter present in current NTAC designs.

The invention described herein is intended to be an exemplar of configurations in accordance with the invention and should not be construed to be limiting except as required to achieve the purposes of the invention.

What is claimed is:

1. Means for minimizing electron back-scatter losses in nuclear thermal avalanche cells, the means comprising electrons emitted from a nuclear thermal avalanche cell emitter, crossing a vacuum gap, and striking one or more electron collector surfaces disposed within a nuclear thermal avalanche cell, and disposing topological surface designs on the one or more electron collector surfaces, the topological surface designs capturing back-scattered electrons.

2. The means of claim 1 wherein the topological surface designs are not co-planar with the plane of the one or more electron collector surfaces.

3. The means of claim 2 wherein the topological surface designs are sawtooth configurations.

4. The means of claim 1 wherein the captured back-scattered electrons are forward-scattered.

5. A device for minimizing electron back-scatter losses in nuclear thermal avalanche cells, the device comprising:
one or more nuclear thermal cell emitters;
one or more electron collector surfaces separated from the one or more nuclear thermal cell emitters by one or more vacuum gaps;
the one or more electron collector surfaces having topological surface designs that are not co-planar with the plane of the one or more electron.

6. The device of claim 4 wherein the topological surface designs are sawtooth designs.

7. Means for maximizing electron forward-scatter emission in nuclear thermal avalanche cells, the means comprising electrons emitted from a nuclear thermal avalanche cell emitter, crossing a vacuum gap, and striking one or more electron collector surfaces disposed within a nuclear thermal avalanche cell, and disposing topological surface designs on the one or more electron collector surfaces, the topological surface designs capturing back-scattered electrons and causing them to be forward-scattered.

8. The means of claim 1 wherein the topological surface designs are not co-planar with the plane of the one or more electron collector surfaces.

9. The means of claim 2 wherein the topological surface designs are sawtooth configurations.
